(19) United States
(12) Patent Application Publication
(10) Pub. No.: US 2019/0347051 A1
(43) Pub. Date: Nov. 14, 2019

(54) PRINT CONTROL METHOD AND PRINT CONTROLLER

(71) Applicant: FUJITSU LIMITED, Kawasaki-shi (JP)

(72) Inventors: Takahiro Ogata, Kawasaki (JP); JUNKI HAKAMATA, Yokohama (JP); Etsushi Fujita, Kawasaki (JP)

(73) Assignee: FUJITSU LIMITED, Kawasaki-shi (JP)

(21) Appl. No.: 16/382,316

(22) Filed: Apr. 12, 2019

(30) Foreign Application Priority Data
May 14, 2018 (JP) 2018-093074

(51) Int. Cl. G06F 3/12

(52) U.S. Cl. CPC G06F 3/1204; G06F 3/1254; G06F 3/1261; G06F 3/1231

(57) ABSTRACT

A print controller includes a memory and a processor coupled to the memory. The memory is configured to store therein print data transmitted from a terminal and first site information in association with each other. The processor is configured to receive, from an instruction device, a printing instruction for printing the print data. The processor is configured to identify second site information corresponding to the instruction device. The processor is configured to determine whether the second site information matches the first site information. The processor is configured to permit to print the print data depending on a result of the determination.

### CROSS-REFERENCE TO RELATED APPLICATION

This application is based upon and claims the benefit of the prior Japanese Patent Application No. 2018-093074, filed on May 14, 2018, the entire contents of which are incorporated herein by reference.

### FIELD

The embodiment discussed herein is related to a print control method and a print controller.

### BACKGROUND

In the related art, in a company or the like, a print management system is introduced which intervenes between a terminal used by a user and a multifunction device having a print function. The print management system mediates the delivery of print data from the terminal to the multifunction device so as to manage printing in the multifunction device. In the print management, there is a print management for each user. With respect to the print management of each user, a technique is known in which restriction information indicating a usage restriction for each user is read when the user has a legitimate authority, and information based on the read restriction information is transmitted so as to manage the usage restriction of each user.

Related techniques are disclosed in, for example, Japanese Laid-open Patent Publication No. 2013-037704, Japanese Laid-open Patent Publication No. 2003-131842, and Japanese Laid-open Patent Publication No. 2009-163404.

However, in the above-described technique of the related art, there is a problem that it is difficult for a company having a plurality of sites such as, for example, branch offices other than the headquarters to manage the printing at each site. For example, in the case of managing the printing of the user belonging to the site for each site and restrict the printing of the user of another site, whenever the user moves between the sites due to a business trip, etc., restriction information on each user has to be changed, and management is very complicated.

### SUMMARY

According to an aspect of the present invention, provided is a print controller including a memory and a processor coupled to the memory. The memory is configured to store therein print data transmitted from a terminal and first site information in association with each other. The processor is configured to receive, from an instruction device, a printing instruction for printing the print data. The processor is configured to identify second site information corresponding to the instruction device. The processor is configured to determine whether the second site information matches the first site information. The processor is configured to permit to print the print data depending on a result of the determination.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a functional configuration example of a print management system according to an embodiment;

FIG. 2 is an explanatory diagram for describing an overview of the print management system according to the embodiment;

FIG. 3 is a flowchart illustrating an operation example of the print management system according to the embodiment;

FIG. 4 is an explanatory diagram for describing a determination on printing availability;

FIG. 5 is an explanatory diagram for describing a determination on printing availability;

FIG. 6 is an explanatory diagram for describing an example of a list screen;

FIG. 7 is an explanatory diagram for describing an example of an error screen;

FIG. 8 is an explanatory diagram for describing a display example of printing availability on a list screen; and

FIG. 9 is an explanatory diagram for describing an example of a hardware configuration.

### DESCRIPTION OF EMBODIMENT

Hereinafter, an embodiment will be described with reference to the accompanying drawings. In the embodiment, components having the same function will be denoted by the same reference numerals, and overlapping descriptions thereof will be omitted. Further, the following embodiment is merely an example, and the embodiments are not limited thereby.

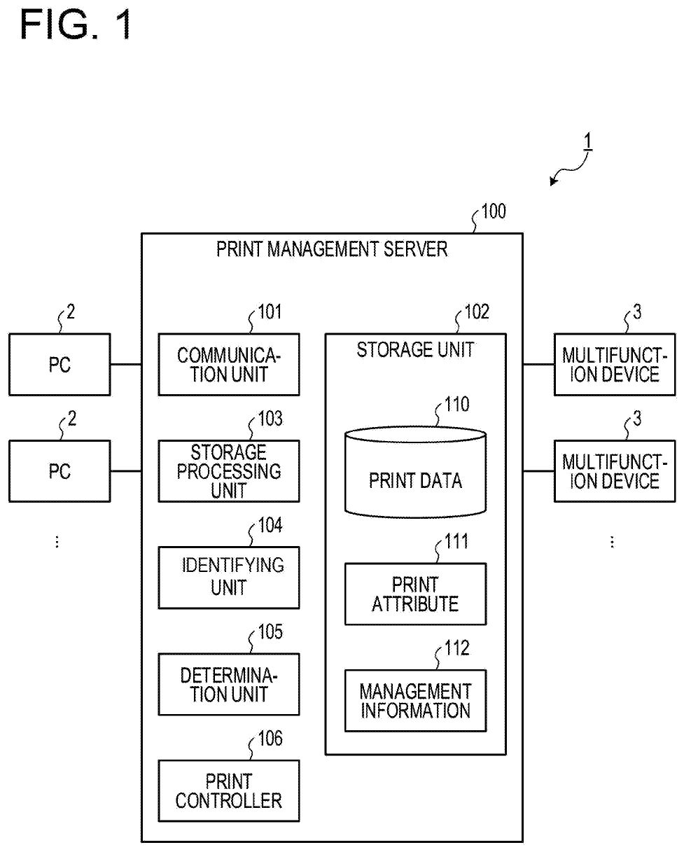

FIG. 1 is a block diagram illustrating a functional configuration example of a print management system according to an embodiment. As illustrated in FIG. 1, in the print management system 1, a personal computer (PC) 2, a multifunction device 3 having a print function, and a print management server 100 are connected to each other so as to be able to communicate with each other via a communication network (not illustrated) such as, for example, a local area network (LAN).

The PC 2 is installed at a plurality of sites such as, for example, branch offices other than the headquarters and is an example of a terminal used by a user at each site. The PC 2 may be, for example, a thin client terminal.

In the same manner as the PC 2, the multifunction device 3 is installed at a plurality of sites and is a device having a plurality of functions such as, for example, a print function, a display/operation function of viewing and operating a print job to be performed, and a scan function. Further, in the present embodiment, it is assumed that the multifunction device 3 has a display/operation function of viewing and operating a print function and a print job.

The print management server 100 mediates the delivery of the print data 110 from the PC 2 to the multifunction device 3 and manages the printing by the multifunction device 3 based on the print data 110.

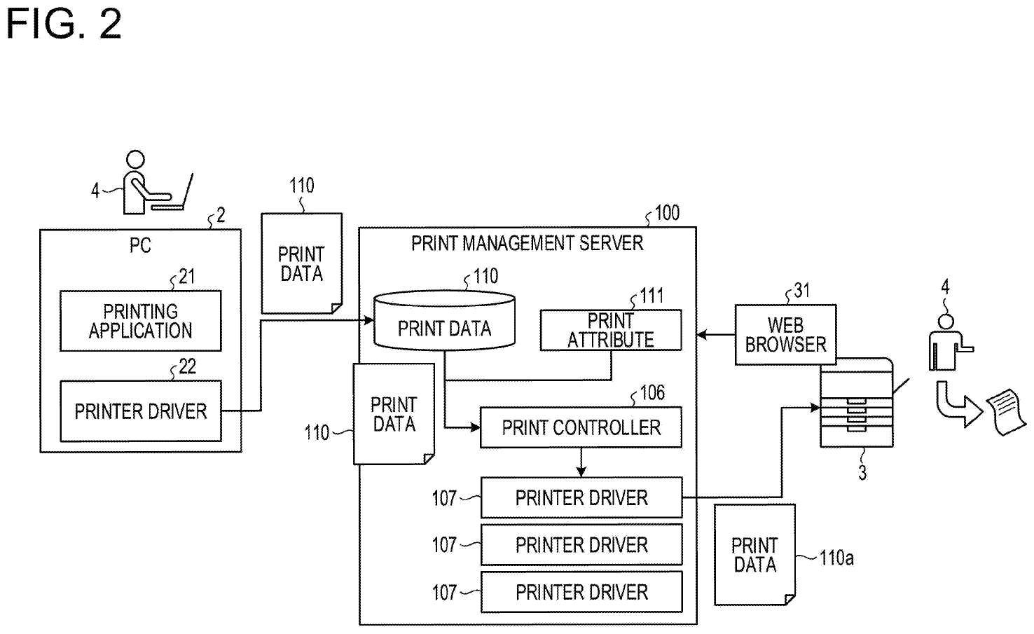

FIG. 2 is an explanatory diagram for describing an overview of the print management system 1 according to the embodiment. As illustrated in FIG. 2, the PC 2 includes a printing application 21 and a printer driver 22. The printing application 21 is, for example, word processing software or spreadsheet software, and is an application that generates document data to be printed. Based on the document data to be printed that is generated by the printing application 21, the printer driver 22 generates print data 110 in which print contents are described by a page description language such as, for example, an XML paper specification (XPS). The printer driver 22 transmits the generated print data 110 to the print management server 100.

The print management server 100 manages the print data 110 sent from the PC 2 by giving identification information such as, for example, a job ID as one print job. Specifically, the print management server 100 gives a unique job ID to the print data 110 sent from the PC 2 and stores the job ID in a storage unit 102. The print data 110 includes attribute information such as, for example, a document name, a user name, a date/time, print settings (monochrome/color/number of pages/number of copies), and site information indicating a site. When storing the attribute information in the storage unit 102, the print management server 100 may read the attribute information included in the print data 110 and manage the attribute information after giving the job ID as a print attribute 111.

In response to a print job viewing request via a web browser 31 of the multifunction device 3, the print management server 100 reads, from the storage unit 102, the print attribute 111 of the print job managed by the print management server 100. Next, the print management server 100 displays a list screen that displays a list of print jobs on the web browser 31 based on the read print attribute 111, and accepts a printing instruction of the print job by a selection operation by a user 4 on the list screen.

When the printing instruction of the print job is received via the web browser 31 of the multifunction device 3, the print controller 106 of the print management server 100 reads the print data 110 of the corresponding print job from the storage unit 102. Next, the print controller 106 generates print data 110a for printing by the multifunction device 3 via the printer driver 107 corresponding to the multifunction device 3 to which the printing instruction is issued, and transmits the print data 110a to the multifunction device 3. The multifunction device 3 executes printing based on the print data 110a transmitted from the print management server 100. As a result, the user 4 may check the print job managed by the print management server 100 from the list screen of the multifunction device 3, and execute printing of a predetermined print job.

Here, the functional configuration of the print management server 100 will be described in detail. As illustrated in FIG. 1, the print management server 100 includes a communication unit 101, a storage unit 102, a storage processing unit 103, an identifying unit 104, a determination unit 105, and a print controller 106.

The communication unit 101 communicates with the PC 2 and the multifunction device 3. Specifically, the communication unit 101 receives the print data 110 and the print attribute 111 of the print data 110 from the PC 2. Further, in response to a viewing request from the web browser 31 of the multifunction device 3 or the like, the communication unit 101 generates display data of a list screen that displays a list of print jobs based on the print attribute 111 stored in the storage unit 102 and transmits the generated display data to the multifunction device 3. The communication unit 101 also receives a printing instruction of a predetermined print job by an operation instruction of the web browser 31 of the multifunction device 3 or the like.

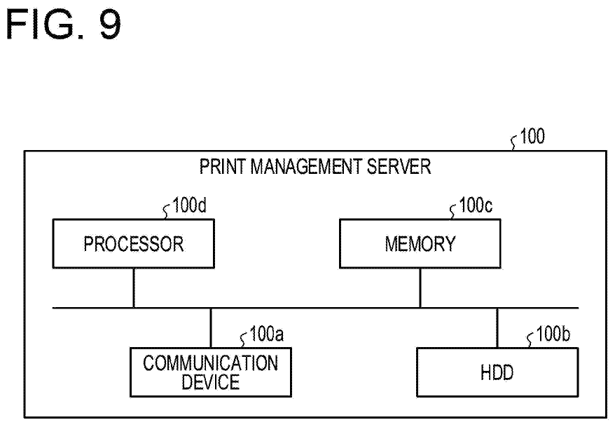

The storage unit 102 is a storage device such as, for example, an HDD 100b (see, e.g., FIG. 9), and stores the print data 110 and the print attribute 111 from the PC 2 and management information 112.

The management information 112 is, for example, the network setting of the print management system 1 and setting data in which various settings are managed for each of the PC 2 and the multifunction device 3, and is preset by an administrator of the print management system 1 or the like. For example, the management information 112 includes site information indicating the site where the assignment is made for each segment of the IP address as the network setting of the print management system 1 (e.g., site names such as Tokyo and Shizuoka). The management information 112 further includes, for example, the name of the multifunction device 3 (e.g., a printer name), the site information indicating the site where the multifunction device 3 is installed (e.g., site names such as Tokyo and Shizuoka), and the network setting (IP address) of the multifunction device 3 as the setting data for each multifunction device 3.

The storage processing unit 103 performs a storage processing such as, for example, storing data in the storage unit 102 and reading data stored in the storage unit 102. Specifically, the storage processing unit 103 gives the print data 110 received from the PC 2 and the print attribute 111 such as the site information sent together with the print data 110 the same job ID, and stores the print data 110 and the print attribute in the storage unit 102. Further, in response to a viewing request from the multifunction device 3 via the communication unit 101, the storage processing unit 103 reads the print attribute 111 of each print job from the storage unit 102 and sends the read print attribute 111 to the communication unit 101. In response to a request from the identifying unit 104 or the determination unit 105, the storage processing unit 103 also reads the print attribute 111 and the identifying unit 104, and sends the read print attribute 111 and identifying unit 104 to the request source.

When a printing instruction is received from the multifunction device 3 (e.g., selection of a predetermined print job on the list screen of print jobs), the identifying unit 104 identifies site information corresponding to the multifunction device 3. Specifically, the identifying unit 104 identifies the site information corresponding to the multifunction device 3 by referring to the management information 112 stored in the storage unit 102 based on the information indicating the multifunction device 3 to which the print instruction is issued (e.g., a printer name and an IP address).

The determination unit 105 determines whether the site information identified by the identifying unit 104 matches the site information of the print attribute 111 stored in the storage unit 102 in association with the print data 110, which is a target of the printing instruction from the multifunction device 3. Specifically, the determination unit 105 reads the print attribute 111 to which the same job ID is given as the job ID in the print data 110 which is a target of the printing instruction from the multifunction device 3. Next, the determination unit 105 determines whether the site information identified by the identifying unit 104 matches the read site information of the print attribute 111.

The print controller 106 controls printing in the multifunction device 3 by the print data 110 stored in the storage unit 102. Specifically, based on the printing instruction from the multifunction device 3 that designates a job ID, etc., the print controller 106 reads the print data 110 corresponding to the job ID from the print data 110 stored in the storage unit 102. Next, the print controller 106 generates the print data 110a corresponding to the multifunction device 3 via the printer driver 107 corresponding to the multifunction device 3 to which the print instruction is issued, and transmits the generated print data 110a from the communication unit 101 to the multifunction device 3.

In addition, the print controller 106 determines whether printing in the multifunction device 3 is available (printing “OK”/“NG”) in accordance with the determination result of the determination unit 105 for the print job to which the printing instruction is issued from the multifunction device 3. For example, for the determination result of the determination unit 105, the print controller 106 determines that printing is “OK” when the site information corresponding to the multifunction device 3 identified by the identifying unit 104 matches the site information in the print job for which the printing instruction is issued, and permits printing. In this manner, the print controller 106 implements print management for each site.

Next, when it is determined that printing in the multifunction device 3 is permitted, the print controller 106 transmits the print data 110a to the multifunction device 3 via the communication unit 101, thereby performing printing of the print job for which the printing instruction is issued. Further, the print controller 106 may notify the multifunction device 3 of the determination result of the printing availability (printing “OK”/“NG”) in the multifunction device 3, and cause the web browser 31 of the multifunction device 3 or the like to display the determination result. As a result, the user 4 who instructs printing by operating the web browser 31 of the multifunction device 3 or the like may check whether printing is possible in the print job for which the printing instruction is issued.

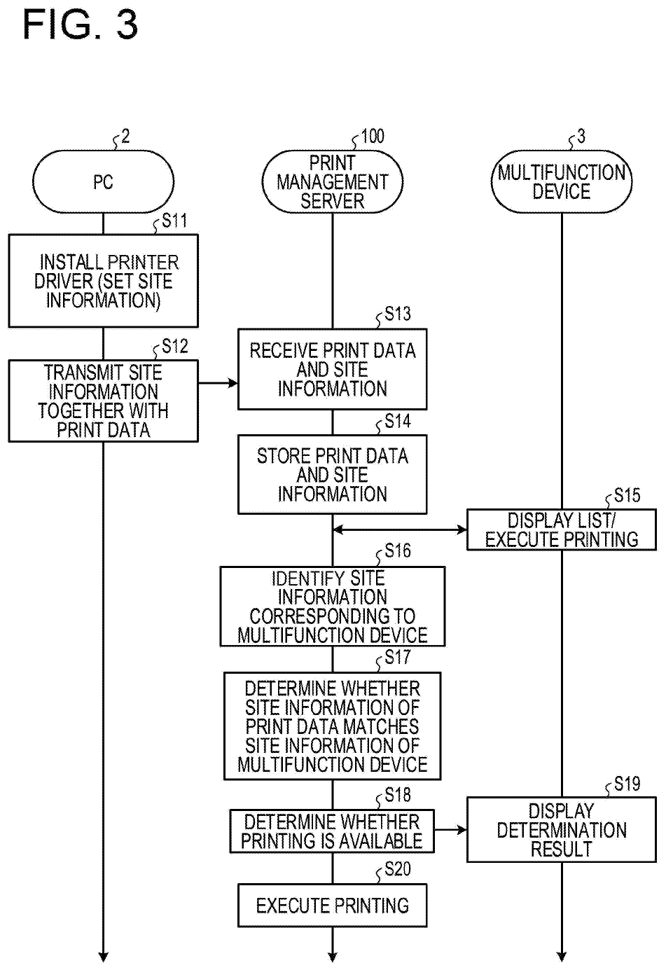

Here, details of the operation in the print management system 1 will be described. FIG. 3 is a flowchart illustrating an operation example of the print management system 1 according to the embodiment.

As illustrated in FIG. 3, in the PC 2, installation of the printer driver 22 is performed prior to generation of the print data 110 (S11). At this time, the PC 2 acquires the site information indicating the printing site at which the printing is to be performed and sets the site information that is acquired as, for example, a part of the setting of the printer driver 22. As an example, an installer of the printer driver 22 in which the site information has been set in advance for each site is prepared, and the PC 2 installs the printer driver 22 with the installer prepared for the printing site so as to set the site information. Further, when installing the printer driver 22, the PC 2 may set the printing site by accepting the operation of the user 4.

Subsequently, the PC 2 generates the print data 110 in the printer driver 22 based on the document data to be printed that is generated by the printing application 21 by the operation of the user 4. At this time, the printer driver 22 gives the set site information to the print data 110 as attribute information. Subsequently, the PC 2 transmits the site information together with the print data 110 to the print management server 100 (S12).

Next, the communication unit 101 of the print management server 100 receives the print data 110 and the site information transmitted from the PC 2 (S13). Subsequently, the storage processing unit 103 of the print management server 100 gives a job ID indicating a print job relating to the received print data 110, and then stores the print data 110 and the site information (print attribute 111) in the storage unit 102 (S14).

Next, based on the operation of the user 4 in the web browser 31 or the like, the multifunction device 3 communicates via the communication unit 101 of the print management server 100, so that the print management server 100 may display a list of print jobs stored in the storage unit 102. In addition, the multifunction device 3 instructs the print management server 100 to execute printing of a predetermined print job by accepting the selection operation of the list-displayed print job from the user 4 (S15).

When receiving the printing instruction from the multifunction device 3, the identifying unit 104 of the print management server 100 refers to the management information 112 and identifies the site information corresponding to the multifunction device 3 (S16).

Subsequently, the determination unit 105 of the print management server 100 determines whether the site information of the print data 110, that is, whether the site information of the print attribute 111 corresponding to the job ID of the print job, for which the printing instruction is issued, matches the site information of the multifunction device 3 (S17). Subsequently, the print controller 106 of the print management server 100 determines whether printing is available (printing “OK”/“NG”) in the multifunction device 3 in accordance with the determination result of the determination unit 105, for the print job for which the printing instruction is issued from the multifunction device 3 (S18).

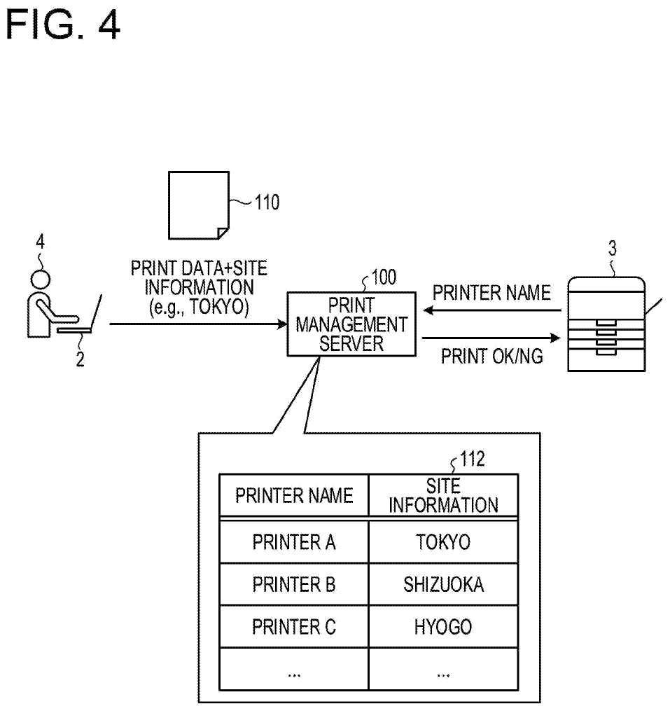

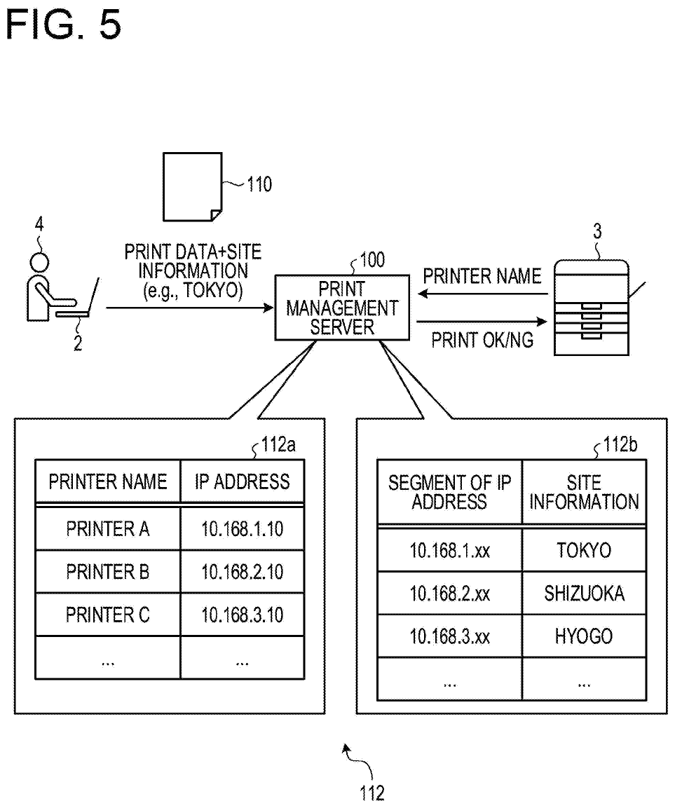

FIGS. 4 and 5 are explanatory diagrams for describing a determination on printing availability. As illustrated in FIGS. 4 and 5, for the print job for which the printing instruction is issued, it is assumed that the site information indicating “Tokyo” is sent from the PC 2 together with the print data 110.

As illustrated in FIG. 4, the identifying unit 104 acquires the printer name of the multifunction device 3 from the communication with the multifunction device 3. Then, based on the printer name acquired from the multifunction device 3, the identifying unit 104 refers to the management information 112 and identifies the site information corresponding to the multifunction device 3. For example, the correspondence relationship between the printer name of the multifunction device 3 (printer A, printer B, . . . ) and the site information indicating the site where the multifunction device 3 is installed (Tokyo, Shizuoka, . . . ) is preset in the management information 112, and the site information corresponding to the printer name may be identified.

Further, as illustrated in FIG. 5, the identifying unit 104 may identify the site information corresponding to the IP address of the multifunction device 3 from which the printing instruction is transmitted, based on a correspondence relationship between the IP address of the multifunction device 3 and the site information. Specifically, the management information 112 has printer-address information 112a and address-site information 112b. The printer-address information 112a is information indicating the correspondence relationship between the printer name of the multifunction device 3 (printer A, printer B, . . . ) and the IP address of the multifunction device 3. The address-site information 112b is information indicating the correspondence relationship between the segment of the IP address and the site information.

For example, the identifying unit 104 identifies the IP address corresponding to the multifunction device 3 by referring to the printer-address information 112a based on the printer name acquired from the multifunction device 3. Next, the identifying unit 104 identifies the site information corresponding to the IP address of the multifunction device 3 by referring to the address-site information 112b based on the segment to which the identified IP address belongs.

Next, the determination unit 105 determines whether the site information of the print data 110 matches the site information corresponding to the multifunction device 3. In accordance with the determination result of the determination unit 105, the print controller 106 determines whether printing is available in the multifunction device 3 (printing “OK”/“NG”). For example, when the site information of the print data 110 matches the site information corresponding to the multifunction device 3, the print controller 106 determines that printing is “OK” and permits printing. Further, when the site information of the print data 110 does not match the site information corresponding to the multifunction device 3, the print controller 106 determines that printing is “NG” and does not permit printing.

Referring back to FIG. 3, the print controller 106 notifies the multifunction device 3 of the determination result of whether printing is available (printing “OK”/“NG”) from the communication unit 101. As a result, in the multifunction device 3, the determination result is displayed on the web browser 31 or the like (S19).

Further, when permitting the printing, the print controller 106 executes printing of the print job for which the printing instruction is issued by transmitting the print data 110a to the multifunction device 3 via the communication unit 101 (S20).

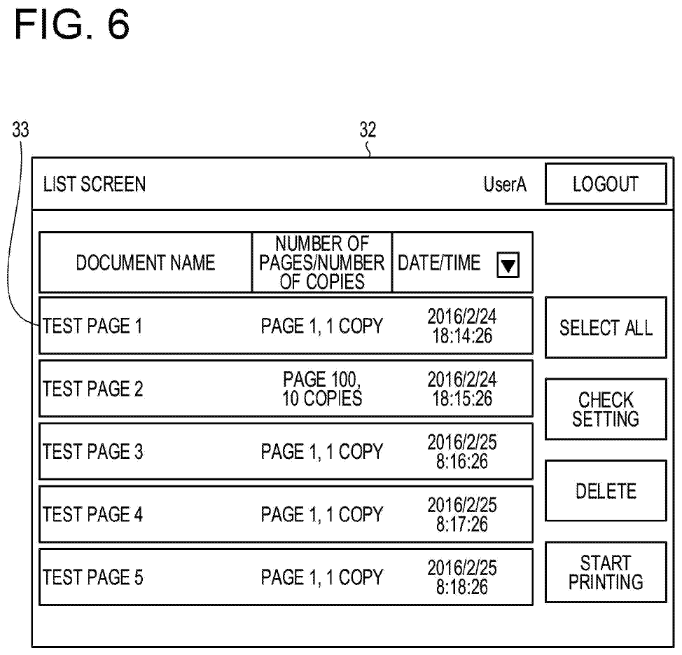

FIG. 6 is an explanatory diagram for describing an example of a list screen. As illustrated in FIG. 6, the multifunction device 3 displays a list of print jobs 33 managed by the print management server 100, as a list screen 32, based on the display data generated from the print management server 100 in response to the viewing request of the web browser 31 or the like. The user 4 instructs printing of the print job 33 by selecting, for example, a predetermined print job 33 on the list screen 32.

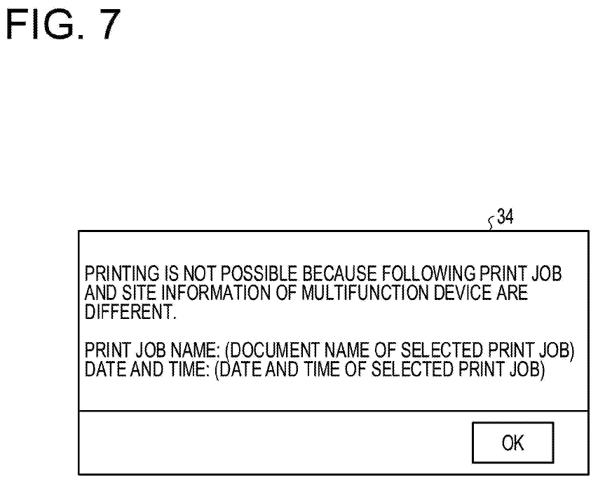

FIG. 7 is an explanatory diagram for describing an example of an error screen. As illustrated in FIG. 7, when it is determined that printing is “NG” for the print job 33 instructed to print, an error screen 34 indicating printing “NG” is displayed by notification from the communication unit 101 of the print management server 100. As a result, the user 4 may check that the print job 33 instructed to print is “NG” due to inconsistency of sites or the like.

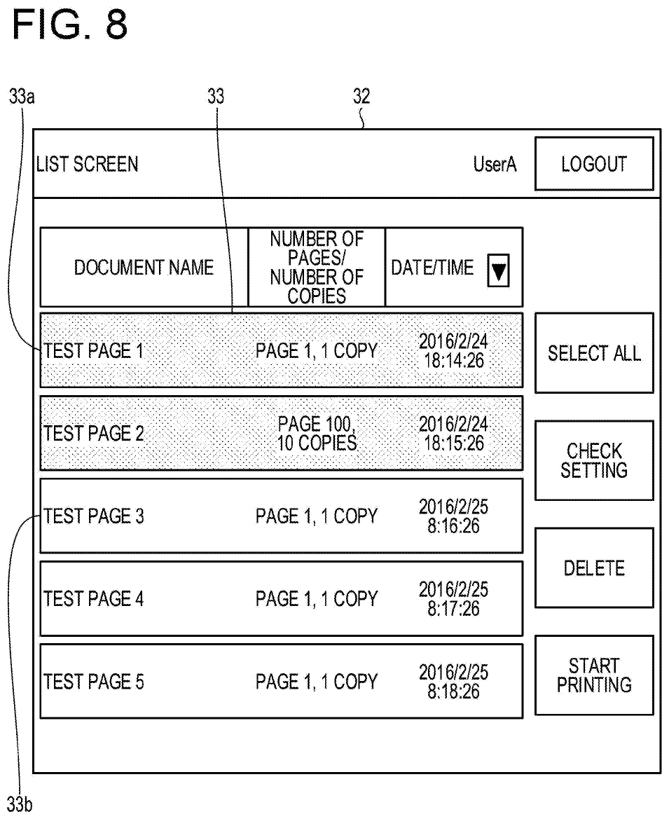

FIG. 8 is an explanatory diagram for describing a display example of printing availability on the list screen 32. As illustrated in FIG. 8, the determination result of the printing availability may be indicated for each print job 33 on the list screen 32. For example, based on the determination result of the determination unit 105, the communication unit 101 of the print management server 100 generates display data in which print job 33a determined to be “printing OK” and print job 33b determined to be “printing NG” are displayed in different display modes, and transmits the display data to the multifunction device 3. As a result, since the print jobs 33a and 32b become different display modes, the printing “OK”/printing “NG” may be easily recognized on the list screen 32.

As described above, when the printing instruction of the print data 110 is received from the multifunction device 3, the print management server 100 refers to the print data 110 transmitted from the PC 2 and the storage unit 102 in which the site information is stored in association with each other, and identifies the site information corresponding to the multifunction device 3. Further, the print management server 100 determines whether the identified site information matches the site information stored in the storage unit 102 in association with the print data 110 as the target of the printing instruction, and permits printing according to the determination result.

As a result, in the print management system 1, printing management for each site may be easily implemented by, for example, permitting a user which belongs to a site to print the print data 110 for each site and restricting printing of the print data 110 by a user at another site.

Further, the site information stored in association with the print data 110 is the site information that is acquired by the PC 2 according to the installation of the printer driver 22 in the PC 2 and transmitted by the PC 2 together with the print data 110. As a result, in the print management system 1, print management for each site may be easily implemented without performing individual user management by using the site information that is acquired by installing the printer driver 22 by the PC 2 such as, for example, a thin client.

In addition, identifying the site information corresponding to the multifunction device 3 is performed based on the correspondence relationship between the IP address of the multifunction device 3 and the site information (see, e.g., FIG. 5) by identifying the site information corresponding to the IP address of the multifunction device 3 as the transmission source of the printing instruction. As a result, in the print management system 1, the site information corresponding to the multifunction device 3 may be identified from the IP address of the multifunction device 3.

Information including processing procedures, control procedures, specific names, various data, and parameters indicated in the document and the drawings may be arbitrarily changed unless otherwise specified. In addition, the specific examples, distribution, numerical values, and the like described in the embodiment are merely examples and may be arbitrarily changed.

Further, the respective constituent elements of the respective devices illustrated in the drawings are functionally conceptual, and do not necessarily have to be physically configured as illustrated. That is, specific forms of distribution and integration of the respective devices are not limited to those illustrated in the drawings. That is, all or a part thereof may be distributed or integrated functionally or physically in arbitrary units according to various loads, usage situations, or the like. Furthermore, all or arbitrary part of the respective processing functions performed in each device may be implemented by a CPU along with a program analyzed and executed by the CPU, or may be implemented as hardware by wired logic.

FIG. 9 is a diagram for describing an example of a hardware configuration. As illustrated in FIG. 9, the print management server 100 includes a communication device 100a, a hard disk drive (HDD) 100b, a memory 100c, and a processor 100d. In addition, the respective units illustrated in FIG. 9 are connected with each other by a bus or the like.

The communication device 100a is, for example, a network interface card, and communicates with other servers. The HDD 100b stores a program that operates the functional units illustrated in FIG. 1 (e.g., the communication unit 101, the storage processing unit 103, the identifying unit 104, the determination unit 105, and the print controller 106). Further, the HDD 100b is an example of the storage unit 102 that stores various types of information to be referred to by executing a program (e.g., print data 110, print attribute 111, and management information 112).

The processor 100d reads, from the HDD 100b or the like, a program that executes the same processes as the respective functional units illustrated in FIG. 1 (e.g., the communication unit 101, the storage processing unit 103, the identifying unit 104, the determination unit 105, and the print controller 106) and develops the program in the memory 100c, thereby operating the process of executing the respective functional units. That is, the process executes the same functions as the respective functional units of the print management server 100 (e.g., the communication unit 101, the storage processing unit 103, the identifying unit 104, the determination unit 105, and the print controller 106). Specifically, the processor 100d reads a program having the same functions as the communication unit 101, the storage processing unit 103, the identifying unit 104, the determination unit 105, the print controller 106, and the like from the HDD 100b and the like. Then, the processor 100d executes the same processes as those of the communication unit 101, the storage processing unit 103, the identifying unit 104, the determination unit 105, the print controller 106, and the like.

As described above, the print management server 100 operates as an information processing apparatus that executes print control of the multifunction device 3 by reading and executing the program. Further, the print management server 100 may also implement the same functions as those in the above-described embodiment by reading the program from a recording medium by a medium reading device and executing the read program. Also, the program is not limited to that which is being executed by the print management server 100. For example, the present disclosure may be similarly applied to a case where another computer, server, or cloud computer executes a program, or a case where these constituent elements cooperatively execute a program.

In addition, this program may be distributed via a network such as, for example, the Internet. Further, this program may be executed by being recorded in a computer-readable recording medium such as, for example, a hard disk, a flexible disk (FD), a CD-ROM, a magneto-optical disk (MO), and a digital versatile disc (DVD) and read out from the recording medium by a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a process, the process comprising:
receiving, from an instruction device, a printing instruction for printing print data stored in a memory in association with first site information, the print data being transmitted from a terminal;
identifying second site information corresponding to the instruction device;
determining whether the second site information matches the first site information; and
permitting to print the print data depending on a result of the determination.

2. The non-transitory computer-readable recording medium according to claim 1, wherein
the first site information is acquired by the terminal when a printer driver is installed in the terminal and transmitted by the terminal together with the print data.

3. The non-transitory computer-readable recording medium according to claim 1, the process further comprising:
identifying the second site information by identifying site information corresponding to an Internet Protocol (IP) address of the instruction device based on a correspondence relationship between the IP address of the instruction device and the second site information.

4. A print control method, comprising:
receiving by a computer, from an instruction device, a printing instruction for printing print data stored in a memory in association with first site information, the print data being transmitted from a terminal;
identifying second site information corresponding to the instruction device;
determining whether the second site information matches the first site information; and
permitting to print the print data depending on a result of the determination.

5. The print control method according to claim 4, wherein
the first site information is acquired by the terminal when a printer driver is installed in the terminal and transmitted by the terminal together with the print data.

6. The print control method according to claim 4, further comprising:
identifying the second site information by identifying site information corresponding to an Internet Protocol (IP) address of the instruction device based on a correspondence relationship between the IP address of the instruction device and the second site information.

7. A print controller, comprising:
a memory configured to store therein print data transmitted from a terminal and first site information in association with each other; and
a processor coupled to the memory and the processor configured to:
receive, from an instruction device, a printing instruction for printing the print data;
identify second site information corresponding to the instruction device;
determine whether the second site information matches the first site information; and
permit to print the print data depending on a result of the determination.

8. The print controller according to claim 7, wherein
the first site information is acquired by the terminal when a printer driver is installed in the terminal and transmitted by the terminal together with the print data.

9. The print controller according to claim 7, wherein
the processor is further configured to:
identify the second site information by identifying site information corresponding to an Internet Protocol (IP) address of the instruction device based on a correspondence relationship between the IP address of the instruction device and the second site information.
